(19) United States
(12) Patent Application Publication
(10) Pub. No.: US 2008/0192648 A1
(43) Pub. Date: Aug. 14, 2008

(54) METHOD AND SYSTEM TO CREATE A VIRTUAL TOPOLOGY

(75) Inventor: Michael Galles, Los Altos, CA (US)

Correspondence Address: SCHWEGMAN, LUNDBERG & WOESSNER, P.A., P.O. BOX 2938, MINNEAPOLIS, MN, 55402, US

(73) Assignee: NUOVA SYSTEMS, SANTA CLARA, CA (US)

(21) Appl. No.: 11/672,716

(22) Filed: Feb. 8, 2007

(51) Int. Cl. H04L 12/28

(52) U.S. Cl. 370/254

(57) ABSTRACT

A method and system to create a virtual topology is provided. The system, in one example embodiment, comprises a network layer to receive a request to create a virtual Peripheral Component Interconnect (PCI) Express device, a device type detector to determine, from the request, a type of the virtual PCI Express device, a virtual device generator to generate a configuration header, the configuration header being in a format of a PCI Express device configuration header, and a topology storage to store the configuration header.

### FIELD

This application relates to method and system to access a service utilizing a virtual communications device.

### BACKGROUND

A data center may be generally thought of as a facility that houses a large amount of computer systems and communications equipment. A data center may be maintained by an organization for the purpose of handling the data necessary for its operations, as well as for the purpose of providing data to other organizations. A data center typically comprises a number of servers that may be configured as so-called stateless servers. A stateless server is a server that has no unique state when it is powered off. An example of a stateless server is a World-Wide Web server (or simply a Web server).

Some of the equipment at a data center may be in the form of servers racked up into 19 inch rack cabinets. Equipment designed to be placed in a rack is typically described as rack-mount, and a single server mounted on a rack may be termed a rack unit. The servers in a data center may include so-called blade servers. Blade servers are self-contained computer servers, designed for high density. Blade servers may have all the functional components to be considered a computer, while many components, such as power, cooling, networking, various interconnects and management, may be removed into a blade enclosure. The blade servers and the blade enclosure together form the blade system.

A data center may be implemented utilizing the principles of virtualization. Virtualization may be understood as, generally, an abstraction of resources, a technique that makes the physical characteristics of a computer system transparent to the user. For example, a single physical server may be configured to appear to the users as multiple servers, each running on a completely dedicated hardware. Such perceived multiple servers may be termed logical servers. On the other hand, virtualization techniques may make appear multiple data storage resources (e.g., disks in a disk array) as a single logical volume or multiple logical volumes, the multiple logical volumes not necessarily corresponding to the hardware boundaries (disks). A layer of system software that permits multiple logical servers to share platform hardware is referred to as a virtual machine monitor.

A virtual machine monitor, often abbreviated as VMM, permits a user to create logical servers. A request from a network client to a target logical server typically includes a network designation of an associated physical server or a switch. When the request is delivered to the physical server, the VMM that runs on the physical server may process the request in order to determine the target logical server and to forward the request to the target logical server. When requests are sent to different services running on a server (e.g., to different logical servers created by a VMM) via a single input/output (I/O) device, the processing at the VMM that is necessary to rout the requests to the appropriate destinations may become an undesirable bottleneck.

### BRIEF DESCRIPTION OF DRAWINGS

Embodiments of the present invention are illustrated by way of example and not limitation in the figures of the accompanying drawings, in which like references indicate similar elements and in which:

FIG. 1 is a diagrammatic representation of a network environment within which an example embodiment may be implemented;

FIG. 2 is a diagrammatic representation of a server system, in accordance with an example embodiment;

FIG. 3 is a diagrammatic representation of an example top of the rack architecture within which an example embodiment may be implemented;

FIG. 4 is a diagrammatic representation of a server system including a Peripheral Component Interconnect (PCI) Express device to provide I/O consolidated, in accordance with an example embodiment;

FIG. 5 is a diagrammatic representation of an example topology of virtual I/O devices, in accordance with an example embodiment;

FIG. 6 is a diagrammatic representation of a PCI Express configuration header that may be utilized in accordance with an example embodiment;

FIG. 7 is a diagrammatic representation of an example consolidated I/O adapter, in accordance with an example embodiment;

FIG. 8 is a flow chart of a method to access a service utilizing a virtual PO device, in accordance with an example embodiment; and

FIG. 9 is a flow chart of a method to create an example topology of virtual I/O devices, in accordance with an example embodiment;

FIG. 10 is a block diagram illustrating a server system including a management CPU that is configured to receive management commands, in accordance with an example embodiment;

FIG. 11 illustrates a diagrammatic representation of an example machine in the form of a computer system within which a set of instructions, for causing the machine to perform any one or more of the methodologies discussed herein, may be executed.

### DETAILED DESCRIPTION

An example adapter is provided to consolidate I/O functionality for a host computer system. An example adaptor, a consolidated I/O adaptor, is a device that is connected to the processor of a host computer system via a Peripheral Component Interconnect (PCI) Express bus. A consolidated I/O adaptor, in one example embodiment, has two consolidated communications links. Each one of the consolidated communications links may have an Ethernet link capability and a Fiber Channel (FC) link capability. In its default configuration, a consolidated I/O adaptor appears to the host computer system as two PCI Express devices.

In one example embodiment, a consolidated I/O adaptor may be configured to present to the host computer system a number of virtual PCI Express devices, e.g., a configurable scalable topology, in order to accommodate specific I/O needs of the host computer system. Each virtual device created by a consolidated I/O adaptor, e.g., each virtual network interface card (virtual NIC or vNIC) and each virtual host bus adaptor (HBA), may be mapped to a particular host address range on the host computer system. In one example embodiment, a vNIC may be associated with a logical server or with a particular service (e.g., a particular web service) running on the logical server. A logical server will be understood to include a virtual machine or a server running directly on the host processor but whose identity and I/O configuration is under central control.

The requests from the network directed to different logical servers that may benefit from a dedicated I/O device, may be channeled, via an example consolidated I/O adaptor, to a host address space range to process messages for that specific logical server. In a scenario where a logical server is associated with a vNIC and is running a service, the requests from network users to utilize the service are received at a host address space range assigned to that vNIC. In some embodiments, additional processing at the host computer system to determine the destination of the request may not be necessary.

In one example embodiment, a virtual I/O device may be provided by an example consolidated I/O adaptor. A virtual I/O device, in one example embodiment, appears to the host computer system and to network users as a physical I/O device.

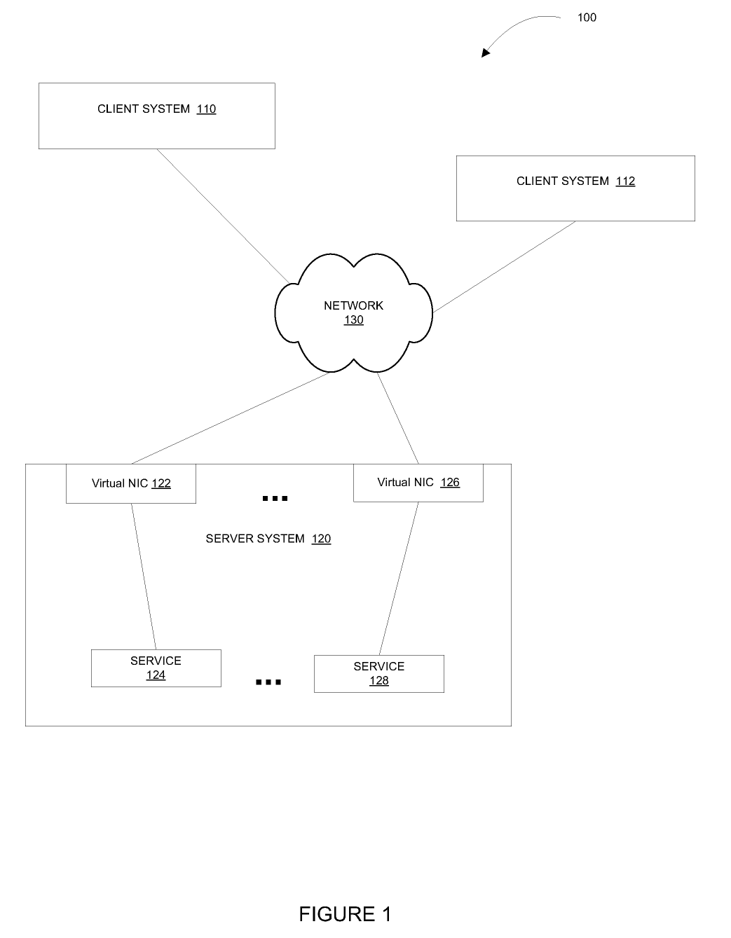

An example embodiment of a system to access a service utilizing a virtual I/O device may be implemented in the context of a network environment. An example of such a network is illustrated in FIG. 1.

FIG. 1 illustrates a network environment 100. The environment 100, in an example embodiment, includes a plurality of client computer systems, e.g., a client system 110 and a client system 112, and a server system 120. The client systems 110 and 112 and the server system 120 are coupled to a communications network 130. The communications network 130 may be a public network (e.g., the Internet, a wireless network, etc.) or a private network (e.g., LAN, WAN, Intranet, etc.). It will be noted, that the client system 110 and the client system 112, while behaving as clients with respect to the server system 120, may be configured to function as servers with respect to some other computer systems.

In an example embodiment, the server system 120 is one of the servers in a data center that provides access to a variety of data and services. The server system 120 may be associated with other server systems, as well as with data storage, e.g., a disk array connected to the server system 120, e.g., via a Fiber Channel (FC) connection or a small computer system interface (SCSI) connection. The messages exchanged between the client systems 110 and 112 and the server system 120, and between the data storage and the server system 120 may be first processed by a router or a switch, as will be discussed further below.

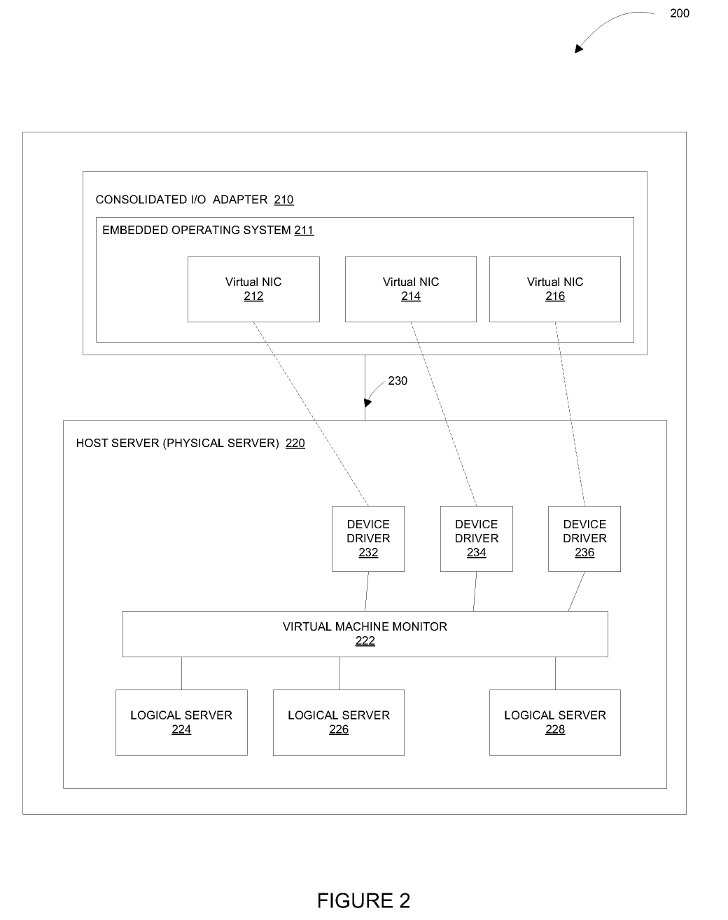

The server system 120, in an example embodiment, may host a service 124 and a service 128. The services 124 and 128 may be made available to the clients 110 and 112 via the network 130. As shown in FIG. 1, the service 124 is associated with a virtual NIC 122, and the service 128 is associated with a virtual NIC 126. In one example embodiment, respective IP addresses associated with the virtual NIC 122 and the virtual NIC 126 are available to the clients 110 and 112. An example embodiment of the server system 120 is illustrated in FIG. 2.

Referring to FIG. 2, a server system 200 includes a host server 220 and a consolidated I/O adapter 210. The consolidated I/O adapter 210 is connected to the host server 220 by means of a PCI Express bus 230. The consolidated I/O adapter 210 is shown to include an embedded operation system 211 hosting multiple virtual NICs: a virtual NIC 212, a virtual NIC 214, and a virtual NIC 216. As shown in FIG. 2, the virtual NIC 212 is shown as mapped to a device driver 232 present on the host server 220. The virtual NIC 214 is shown as mapped to a device driver 232. The virtual NIC 216 is shown as mapped to a device driver 232. In one example embodiment, the consolidated I/O adapter 210 is capable of supporting up to 128 virtual NICs. It will be noted that, in one example embodiment, the consolidated I/O adapter 210 may be configured to have virtual PCI bridges and virtual host bus adaptors (vHBAs), as well as other virtual PCI Express endpoints and connectivity devices, in addition to virtual NICs.

The host server 220, as shown in FIG. 2, may host a virtual machine monitor (VMM) 222 and plurality of logical servers 224 and 226 (e.g., implemented as guest operating systems). The logical servers created by the VMM 222 may be referred to as virtual machines. In one example embodiment, the host server 220 may be configured such that the network messages directed to the logical server 224 are processed via the virtual NIC 212, while the network messages directed to the logical server 226 are processed via the virtual NIC 214. The network messages directed to a logical server 228 are processed via the virtual NIC 218.

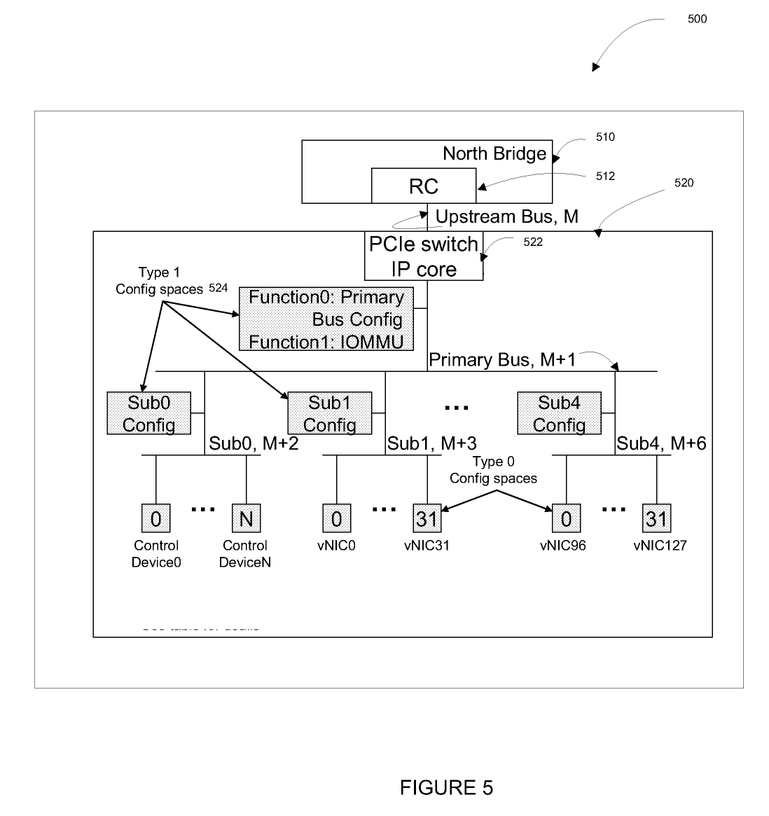

In one example embodiment, the consolidated I/O adapter 210 has an architecture, in which the identity of the consolidated I/O adaptor 210 (e.g., the MAC address and configuration parameters) is managed centrally and is provisioned via the network. In addition to the ability to provision the identity of the consolidated I/O adapter 210 via the network, the example architecture may also provide an ability for the network to provision the component interconnect bus topology, such as virtual PCI Express topology. An example virtual topology hosted on the consolidated I/O adapter 210 is discussed further below, with reference to FIG. 5.

In one example embodiment, each of the virtual NICs 212, 214, and 216 has a distinct MAC address, so that these virtual devices that may be virtualized from the same hardware pool are indistinguishable from separate physical devices, when viewed from the network or from the host server 220. A logical server, e.g., the logical server 224, may have associated attributes to indicate the required resources, such as the number of Ethernet cards, the MAC addresses associated with the Ethernet cards, the IP addresses, the number of HBAs, etc.

Returning to FIG. 2, a client who connects to the virtual NIC 212 may communicate with the logical server 224, in the same manner as if the logical server 224 was a dedicated physical server. If a packet is sent from a client to the logical server 224 via the virtual NIC 212, the packet targets the IP address and the MAC address associated with the virtual NIC 212.

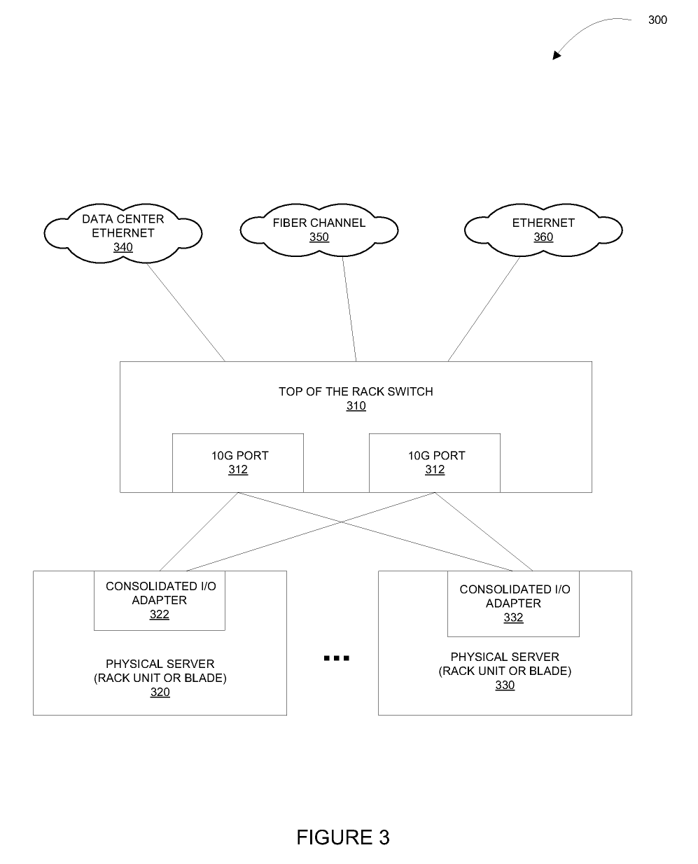

The server system 200 may be advantageously utilized in the context of a data center, where a plurality of servers (e.g., rack units or blade servers) may be communicating with one or more networks via a switch. A switch that functions to provide centralized network access to a plurality of servers may be termed a top of the rack (TOR) switch. FIG. 3 is a diagrammatic representation of an example top of the rack architecture within which an example embodiment may be implemented.

FIG. 3 illustrates physical servers 320 and 330 connected, to a top of the rack switch 310, via their respective consolidated I/O adaptors 322 and 332. The physical servers 320 and 330, in one example embodiment, are rack units provided at a data center. In another embodiment, the physical servers 320 and 330 may be blade servers. The servers 320 and 330 may be configured as diskless servers.

The top of the rack switch 310, in one example embodiment, is equipped with two 10G Ethernet ports, a port 312 and a port 314. The 10 Gigabit Ethernet standard (IEEE 802.3ae 2002) operates in full duplex mode over optical fiber and allows Ethernet to progress, as the name suggests, to 10 gigabits per second.

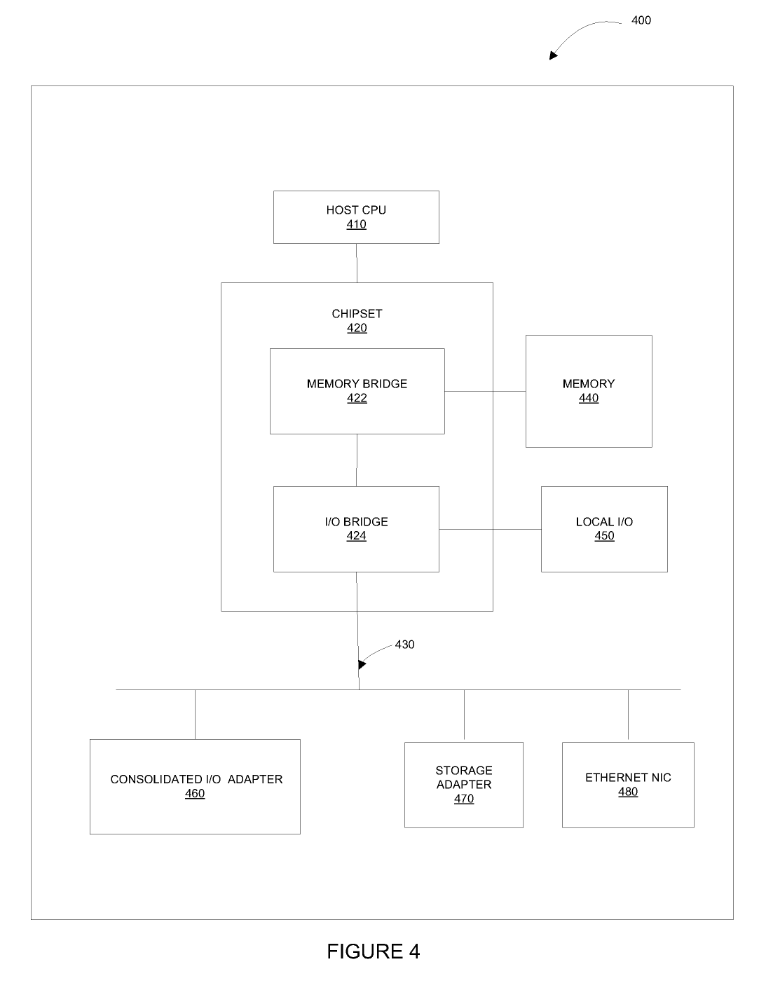

The top of the rack switch 310, in one example embodiment, may be configured to connect to Data Center Ethernet (DCE) 340, Fiber Channel (FC) 350, and Ethernet 360. The Ethernet 360 may be utilized to communicate with network clients and to process requests to access various services provided by the data center. The FC 350 may be utilized to provide a connection between the servers in the data center, e.g., the servers 320 and 330, and a disk array (not shown). The DCE 340 may be used to provide connection between the servers in the rack and other top of the rack switches or other DCE switches in the data center. An example embodiment of a server system including a PCI Express device to provide I/O consolidation is discussed with reference to FIG. 4.

FIG. 4 is a diagrammatic representation of a server system 400, in accordance with an example embodiment. As shown in FIG. 4, a host CPU 410 may be connected to various peripheral devices via a PCI Express bus 430 by means of a chipset 420. The chipset 420, in one example embodiment, includes a memory bridge 422 and an I/O bridge 424. The memory bridge 422 may be connected to a memory 440. The I/O bridge 424 may be connected, in one embodiment, to a local I/O device 450. As shown in FIG. 4, the I/O bridge also provides connection to the PCI Express bus 430.

The PCI Express is an implementation of the PCI connection standard that is based on serial physical-layer communications protocol, while using existing PCI programming concepts. The serial technology used by the PCI Express bus enables the data arriving from a peripheral device to the CPU and the data communicated from the CPU to the peripheral device to travel along different pathways.

The PCI Express bus 430 in FIG. 4 is shown to connect several peripheral devices with the host CPU 410. The fundamental unit of a PCI Express bus is a PCI Express device. PCI Express devices include traditional endpoints, such as a single NIC or a single HBA, as well as bridge and switch structures used to build out a PCI Express topology. The example peripheral devices illustrated in FIG. 4 are a consolidated I/O adaptor 460, a storage adaptor 470, and an Ethernet NIC 480. As discussed above, the virtual PCI Express devices created by the consolidated I/O adaptor 460 are indistinguishable from physical PCI Express devices by the host CPU 410.

A PCI Express device is typically associated with a host software driver. In one example embodiment, each virtual entity created by the consolidated I/O adaptor 460 that requires a separate host driver is defined as a separate device. Every PCI Express device has an associated configuration space, which allows the host software to perform example functions, such as listed below.
Detect PCI Express devices after reset or hot plug events.
Identify the vendor and function of each PCI Express device.
Discover what system resources each PCI Express device needs, such as memory address space and interrupts.
Assign system resources to each PCI Express device, including PCI address space and interrupts.
Enable or disable the ability of the PCI Express device to respond to memory or I/O accesses.
Instruct the PCI Express device on how to respond to error conditions.
Program the routing of PCI Express device interrupts.

Each PCI Express device that appears in the configuration space is either of Type 0 or of Type 1. Type 0 devices, represented in the configuration space by Type 0 headers in the associated configuration space, are endpoints, such as NICs. Type 1 devices, represented in the configuration space by Type 1 headers, are connectivity devices, such as switches and bridges. Connectivity devices, in one example embodiment, may be implemented with additional functionality beyond the basic bridge or switch functionality.

For example, a connectivity device may be implemented to include an I/O memory management unit (IOMMU) control interface. The IOMMU is not an endpoint, but rather a function that may be attached to the primary PCI Express bridge. The IOMMU typically identifies itself as a PCI Express capability present on the primary bridge. The IOMMU control interface and status information may be mapped to the PCI configuration space using a PCI bridge capability block. The bridge capability block describes the services and status of the bridge itself, and may be accessed with PCIe configuration transactions in the same manner which endpoints are accessed. The IOMMU may appear as a function on the primary bus of a consolidated I/O adaptor and may be configured to be aware of all virtual addresses flowing from virtual devices created by a consolidated I/O adaptor to the root complex (RC). The IOMMU may be configured to translate virtual addresses from the endpoint devices to physical addresses in the host memory. The primary bus of a consolidated I/O adaptor, in one example embodiment, is the location in the topology created by a consolidated I/O adaptor that provides visibility to all upstream transactions. FIG. 5 shows an example PCI Express topology that may be created by a consolidated I/O adaptor.

As shown in FIG. 5, a consolidated I/O adaptor 520 is connected to a North Bridge 510 of a chipset of a host server via an upstream bus M. The upstream bus (M) is connected to an RC 512 of the North Bridge 510 and to a PCI Express IP core 522 of the consolidated I/O adaptor 520. The PCI Express IP core 522 is associated with a vendor-provided IP address.

The example topology includes a primary bus (M+1) and secondary buses (Sub0, M+2), (Sub 1, M+3), and (Sub4, M+6). Coupled to the secondary bus (Sub0, M+2), there is a number of control devices—control device 0 through control device N. Coupled to the secondary buses (Sub1, M+3) and (Sub4, M+6), there are a number of virtual endpoint devices: vNIC 0 through vNIC N.

Bridging the PCI Express IP core 522 and the primary bus (M+1), there is a Type 1 PCI Express device 524 that provides a basic bridge function, as well as the IOMMU control interface. Bridging the primary bus (M+1) and (Sub0, M+2), (Subl, M+3), and (Sub4, M+6), there are other Type 1 PCI Express devices 524: (Sub0 config), (Sub1 config), and (Sub4 config).

Depending on the desired system configuration, which, in one example embodiment, is controlled by an embedded management CPU incorporated into the consolidated I/O adaptor 520, any permissible PCI Express topology and device combination can be made visible to the host server. For example, the hardware of the consolidated I/O adaptor 520, in one example embodiment, may be capable of representing a maximally configured PCI Express configuration space which, in one example embodiment, includes 64K devices. Table 1 below details the PCI Express configuration space as seen by host software for the example topology shown in FIG. 5.

TABLE 1

| Bus | Dev | Func | Description |
|---|---|---|---|
| Upstream | 0 | 0 | Primary PCI Bus config device, connects upstream port to |
| | | | sub busses |
| Upstream | 0 | 1 | IOMMU control interface |
| Primary | 0 | 0 | Sub0 PCI Bus config device, connects primary bus to sub0 |
| Primary | 1 | 0 | Sub1 PCI Bus config device, connects primary bus to sub1 |
| Primary | 2 | 0 | Sub2 PCI Bus config device, connects primary bus to sub2 |
| Primary | 3 | 0 | Sub3 PCI Bus config device, connects primary bus to sub3 |
| Primary | 4 | 0 | Sub4 PCI Bus config device, connects primary bus to sub4 |
| Primary | 5–31 | | Not configured or enabled in this example system |
| Sub0 | 0 | 0 | Palo control interface. Provides a messaging interface |
| | | | between the host CPU and management CPU. |
| Sub0 | 1 | 0 | Internal “switch” configuration: VLANs, filtering |
| Sub0 | 2 | 0 | DCE port 0, phy |
| Sub0 | 3 | 0 | DCE port 1, phy |
| Sub0 | 4 | 0 | 10/100 Enet interface to local BMC |
| Sub0 | 5 | 0 | FCoE gateway 0 (TBD, if we use ext. HBAs) |
| Sub0 | 6 | 0 | FCoE gateway 1 (TBD, if we use ext. HBAs) |
| Sub0 | 7–31 | | Not configured or enabled in this example system |
| Sub1 | 0–31 | 0 | vNIC0–vNIC31 |
| Sub2 | 0–31 | 0 | vNIC32–vNIC63 |
| Sub3 | 0–31 | 0 | vNIC64–vNIC95 |
| Sub4 | 0–31 | 0 | vNIC96–vNIC127 |
| Sub5–Sub31 | | | Not configured or enabled in this example system |

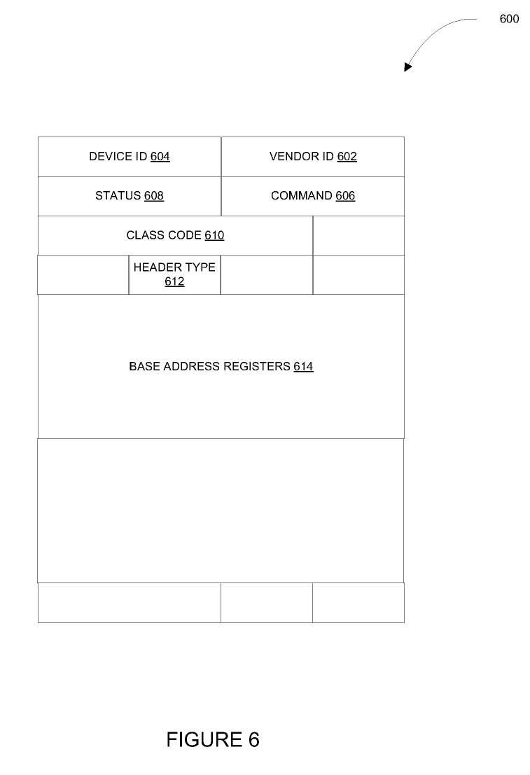

FIG. 6 is a diagrammatic representation of a PCI Express configuration header 600 that may be utilized in accordance with an example embodiment. As shown in FIG. 6, the header 600 includes a number of fields. When the host CPU scans the PCI Express bus, it detects the presence of a PCI Express device by reading the existing configuration headers. A Vendor ID Register 602 identifies the manufacturer of the device by a code. In one example embodiment, the value FFFFh is reserved and is returned by the host/PCI Express bridge in response to an attempt to read the Vendor ID Register field for an empty PCI Express bus slot. A Device ID Register 604 is a 16-bit value that identifies the type of device. The contents of a Command Register specify various functions, such as I/O Access Enable, Memory Access Enable, Master Enable, Special Cycle Recognition, System Error Enable, as well as other functions.

A Status Register 608 may be configured to maintain the status of events related to the PCI Express bus. A Class Code Register 610 identifies the main function of the device, a more precise subclass of the device, and, in some cases, an associated programming interface.

A Header Type Register 612 defines the format of the configuration header. As mentioned above, a Type 0 header indicates an endpoint device, such as a network adaptor or a storage adaptor, and a Type 1 header indicates a connectivity device, such as a switch or a bridge. The Header Type Register 612 may also include information that indicates whether the device is unifunctional or multifunctional.

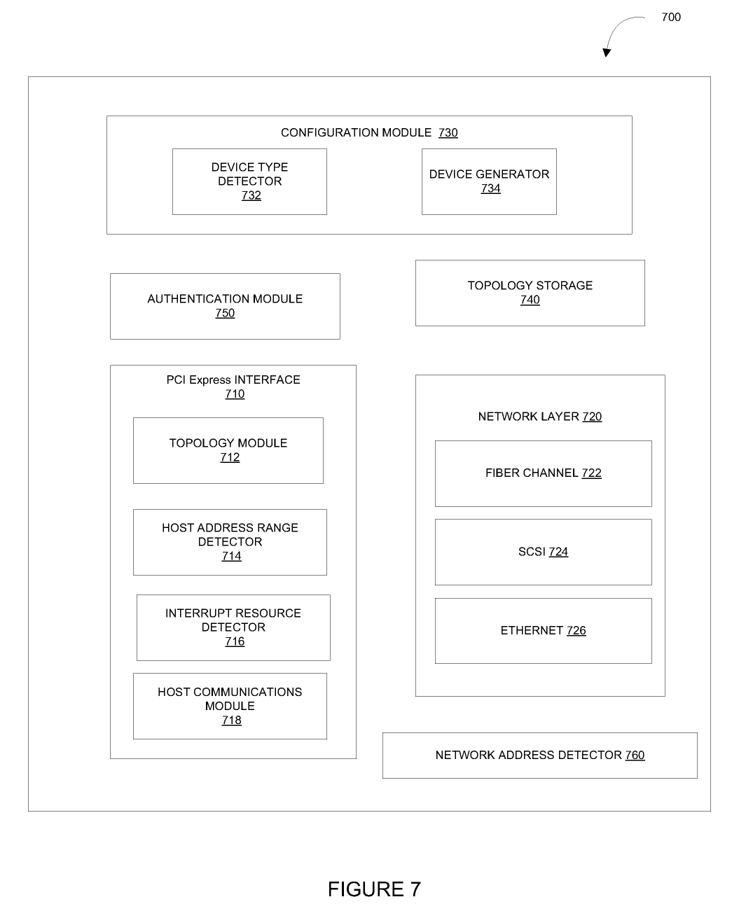

FIG. 7 is a diagrammatic representation of an example consolidated I/O adapter 700, in accordance with an example embodiment. As shown in FIG. 7, the consolidated I/O adapter 700 includes a PCI Express interface 710 to provide communications channel between the consolidated I/O adapter 700 and the host server, a network layer 720 to facilitate communications between the consolidated I/O adapter 700 and remote network entities, an authentication module 750 to authenticate any requests that arrive to the consolidated I/O adapter 700, and a network address detector 760 to analyze network requests and to determine a network address associated with the target virtual device associated with the request. The network layer 720, in one example embodiment, includes a Fiber Channel module 722 to send and receive communications over Fiber Channel, a small computer system interface (SCSI) module 724 to send and receive communications from SCSI devices, and an Ethernet module 726 to send and receive communications over Ethernet.

In one example embodiment, when a request directed to a service running on the host server is received by the network layer 720, the request is first authenticated by the authentication module 750. The network address detector 760 may then parse the request to determine the network address associated with the service and pass the control to the PCI Express interface 710.

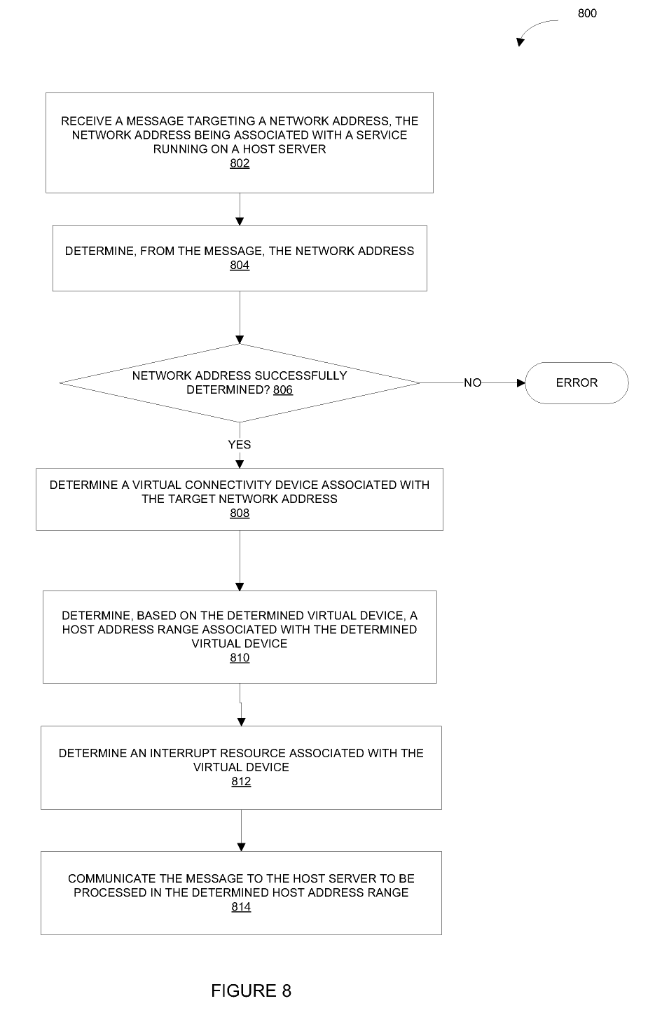

The PCI Express interface 710, in one example embodiment, includes a topology module 712 to determine a target virtual device maintained by the consolidated I/O adapter 700 that is associated with the network address indicated in the request. The PCI Express interface 710 may also include a host address range detector 714 to determine the host address range associated with the target virtual device, an interrupt resource detector 716 to determine an interrupt resource associated with the virtual communications device, and a host communications module 718 to communicate the request to the host server to be processed in the determined host address range. The example operations performed by the I/O consolidated adapter 700 to create a topology may be described with reference to FIG. 8.

FIG. 8 is a flow chart of a method 800 to access a service utilizing a virtual communications device, in accordance with an example embodiment. The method 800 to access a service may be performed by processing logic that may comprise hardware (e.g., dedicated logic, programmable logic, microcode, etc.), software (such as run on a general purpose computer system or a dedicated machine), or a combination of both. In one example embodiment, the method 800 may be performed by the various modules discussed above with reference to FIG. 7. Each of these modules may comprise processing logic.

As shown in FIG. 8, at operation 802, the network layer 720 of the consolidated I/O adaptor receives a message from a network client. In one embodiment, the message may be a request from a remote client targeting a network address associated with a particular service running on the host server. At operation 804, the network address detector 760 determines, from the request, the target network address that is being targeted. The network address may be an Internet protocol (IP) address. If it is determined, at operation 806, that the network address detector 760 successfully determined the target network address, the method 800 continues to operation 808. If the network address detector 760 fails to determine the target network address, the method 800 terminates with an error.

At operation 808, the topology module 712 of the PCI express interface 710 determines a virtual communications device (e.g., a virtual NIC) associated with the target network address. At operation 810, the host address range detector 714 determines the host address range associated with the determined virtual communications device. An interrupt resource detector 716 may then determine an interrupt resource associated with the virtual communications device at operation 812. The method then proceeds to operation 814. At operation 814, the host communications module 718 communicates the message to the host server, the message to be processed in the determined host address range.

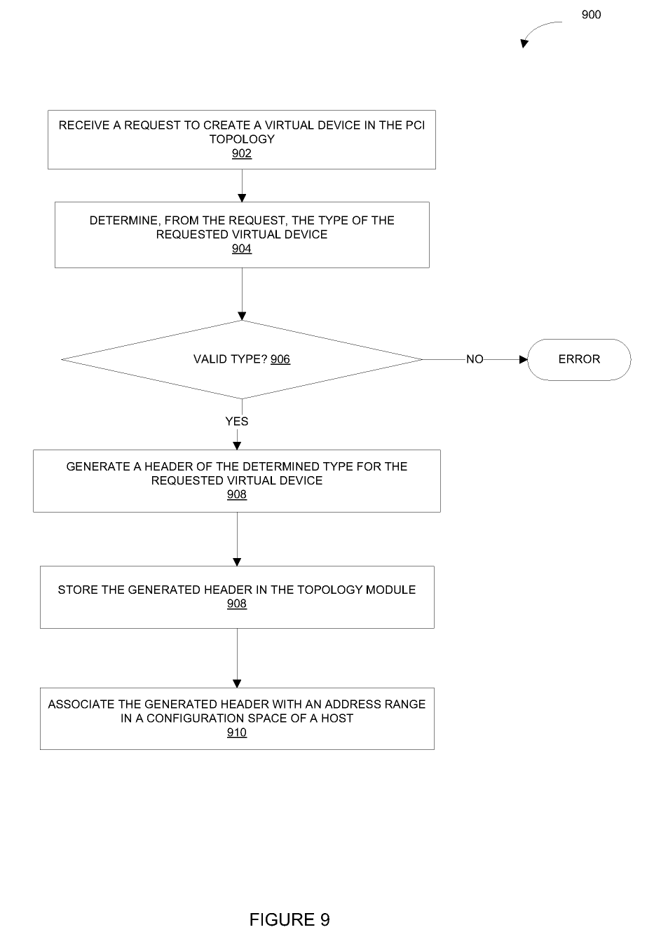

Returning to FIG. 7, the consolidated I/O adapter 700, in one example embodiment, is configured to provision a scalable topology of PCI Express devices to the host software running on the host server. The consolidated I/O adapter 700 may include a configuration module 730 to create a PCI Express devices topology. The configuration module 730, in one example embodiment, comprises a management CPU. In other example embodiments, operations performed by the configuration module 730 may be performed by dedicated hardware or by a remote system using a management communications protocol. The configuration module 730 may be engaged by a request received from the network, and may not require any control instructions from the host server. The configuration module 730 may include a device type detector 732 to determine whether a virtual endpoint device or a virtual connectivity device is to be created and a device generator 734 to generate the requested virtual device. The example operations performed by the I/O consolidated adapter 700 to create a topology may be described with reference to FIG. 9.

The method 900 to create a topology may be performed by processing logic that may comprise hardware (e.g., dedicated logic, programmable logic, microcode, etc.), software (such as run on a general purpose computer system or a dedicated machine), or a combination of both. In one example embodiment, the method 900 may be performed by the various modules discussed above with reference to FIG. 7. Each of these modules may comprise processing logic.

As shown in FIG. 9, the method 900 commences at operation 902. At operation 902, the network layer 720 receives a request from the network, e.g. from a user with administrator's privileges, to create a virtual communications device in the PCI Express topology. At operation 904, the device type detector 732 of the configuration module 730 determines, from the request, the type of the requested virtual communications device. As mentioned above, the requested virtual device may be a PCI Express connectivity device or a PCI Express endpoint device. If it is determined, at operation 906, that the type of the requested device is valid the method proceeds to operation 908. If the type of the requested virtual device is an invalid type, the method 900 terminates within an error.

At operation 908, the control is passed to the configuration module 730. The device generator 734 generates a PCI Express configuration header of the determined type for the requested virtual device. The device generator 734 then stores the generated PCI Express configuration header in the topology storage module 740, at operation 910. At operation 912, the generated PCI Express configuration header is associated with an address range in the memory of the host server.

In one example embodiment, a request to create a virtual communications device in the PCI Express topology may be referred to as a management command and may be directed to a management CPU.

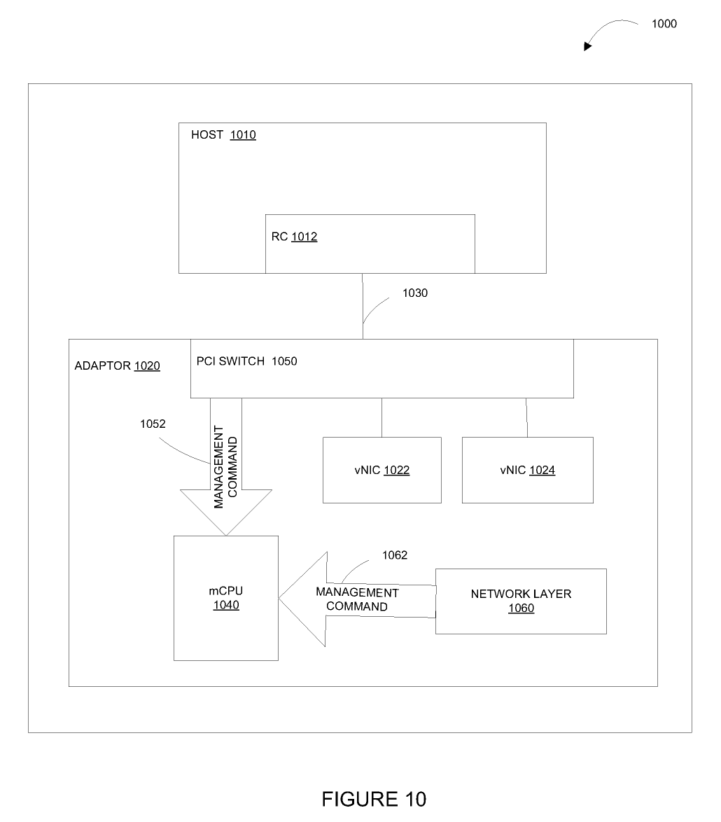

FIG. 10 is a block diagram illustrating a server system 1000 including a management CPU that is configured to receive management commands. The example server system 1000, as shown in FIG. 10, includes a host server 1010 and a consolidated I/O adapter 1020. The host server 1010 and the consolidated I/O adapter 1020 are connected by means of a PCI Express bus 1030 via an RC 1012 of the host server 1010 and a PCI switch 1050 of the consolidated I/O adapter 1020. The consolidated I/O adapter 1020 is shown to include a management CPU 1040, a network layer 1060, a virtual NIC 1022, and a virtual NIC 1024. The management CPU 1040, in one example embodiment, may receive management commands from the host server 1010 via the PCI switch 1050, as well as from the network via the network layer 1060, as indicated by blocks 1052 and 1062.

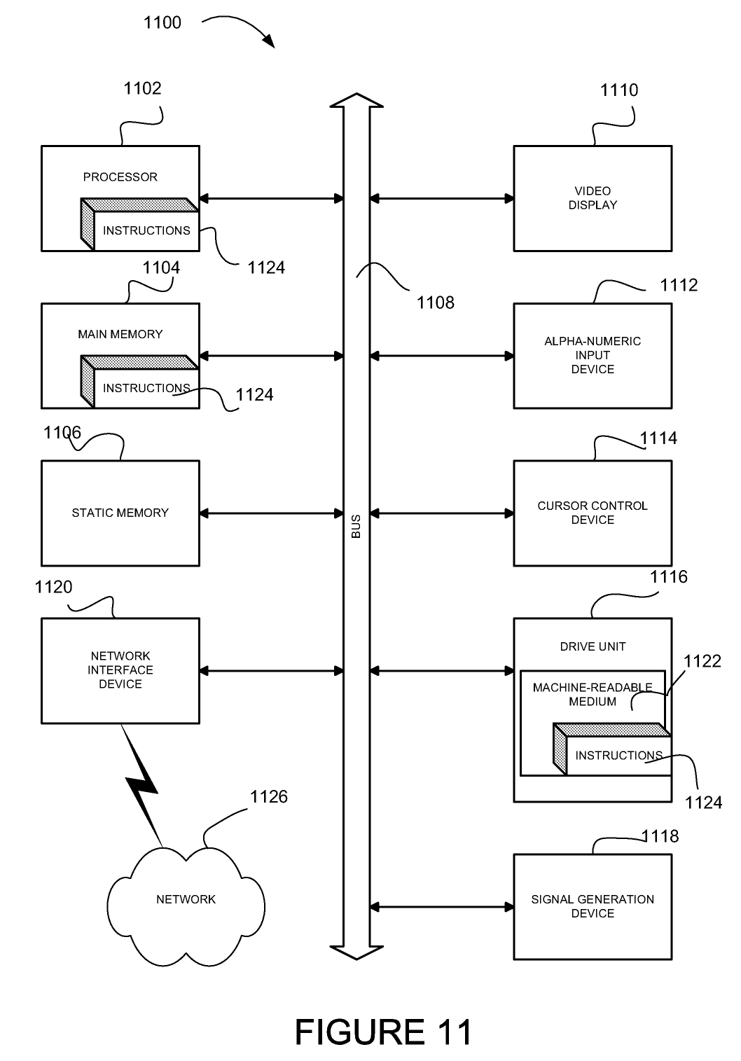

FIG. 11 shows a diagrammatic representation of machine in the example form of a computer system 1100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a voice mail system, a cellular telephone, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 11104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), optionally a user interface (UI) navigation device 1114 (e.g., a mouse), optionally a disk drive unit 1116, a signal generation device 1118 (e.g., a speaker) and a network interface device 1120.

The disk drive unit 1116 includes a machine-readable medium 1122 on which is stored one or more sets of instructions and data structures (e.g., software 1124) embodying or utilized by any one or more of the methodologies or functions described herein. The software 1124 may also reside, completely or at least partially, within the main memory 1104 and/or within the processor 1102 during execution thereof by the computer system 1100, the main memory 1104 and the processor 1102 also constituting machine-readable media.

The software 1124 may further be transmitted or received over a network 1126 via the network interface device 1120 utilizing any one of a number of well-known transfer protocols, e.g., a Hyper Text Transfer Protocol (HTTP).

While the machine-readable medium 1122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such medium may also include, without limitation, hard disks, floppy disks, flash memory cards, digital video disks, random access memory (RAM), read only memory (ROMs), and the like.

The embodiments described herein may be implemented in an operating environment comprising software installed on any programmable device, in hardware, or in a combination of software and hardware.

Thus, a method and system to access a service utilizing a virtual communications device have been described. Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A system comprising:
a network layer to receive a request to create a virtual Peripheral Component Interconnect (PCI) Express device;
a device type detector to determine, from the request, a type of the virtual PCI Express device;
a virtual device generator to generate a configuration header, the configuration header being in a format of a PCI Express device configuration header; and
a topology storage to store the configuration header.

2. The system of claim 1, wherein the type of the virtual device is of a type corresponding to an endpoint device.

3. The system of claim 2, wherein the virtual device is a virtual Network Interface Card (NIC).

4. The system of claim 1, wherein the type of the virtual device is of a type corresponding to a connectivity device.

5. The system of claim 4, wherein the virtual device is to provide I/O memory mapping unit (IOMMU) control interface.

6. The system of claim 1, wherein the network layer is to receive the request to create the virtual PCI Express device from a remote administrator.

7. The system of claim 1, further comprising a PCI Express interface to present the virtual device to a host server as a physical device.

8. The system of claim 1 wherein the virtual device generator is to associate the virtual device with a service running on a host server.

9. The system of claim 1, wherein the host server is a blade server.

10. The system of claim 9, wherein the host server is a rack unit server.

11. A method comprising:
receiving a request to create a virtual Peripheral Component Interconnect (PCI) Express device;
determining, from the request, a type of the virtual PCI Express device;
generating a configuration header, the configuration header being in a format of a PCI Express device configuration header; and
storing the configuration header.

12. The method of claim 11, wherein the type of the virtual device is of a type corresponding to an endpoint device.

13. The method of claim 2, wherein the virtual device is a virtual Network Interface Card (NIC).

14. The method of claim 11, wherein the type of the virtual device is of a type corresponding to a connectivity device.

15. The method of claim 14, wherein the virtual device is to provide I/O memory mapping unit (IOMMU) control interface.

16. The method of claim 11, wherein the network layer is to receive the request to create the virtual PCI Express device from a remote administrator.

17. The method of claim 11, further comprising a PCI Express interface to present the virtual device to a host server as a physical device.

18. The method of claim 11 wherein the virtual device generator is to associate the virtual device with a service running on a host server.

19. The method of claim 11, wherein the host server is a blade server.

20. The method of claim 19, wherein the host server is a rack unit server.

21. A consolidated input/output (I/O) adaptor, the adaptor comprising:
a configuration module to generate virtual topology, the virtual topology comprising a plurality of virtual Peripheral Component Interconnect (PCI) Express devices, a device from the plurality of virtual PCIe devices having an associated IP address, the IP address being owned by the consolidated I/O adaptor;
a memory to store the virtual topology;
a PCIe interface to communicate the virtual topology to a host computer system; and
a network layer to communicate the virtual topology to network entities.

22. The system of claim 21, wherein the configuration module is a management central processing unit (CPU).

23. The system of claim 21, wherein the configuration module is in communication with a remote system, utilizing a management communications protocol.

24. The system of claim 21, wherein the configuration module comprises dedicated hardware.

25. A system comprising:
a host server, the host server comprising:
a central processing unit (CPU),
a host memory, and
a Peripheral Component Interconnect (PCI) Express bus; and
a consolidated input/output (I/O) adaptor connected to the host server via the PCI Express bus, the consolidated I/O adaptor comprising:
a management central processing unit (CPU) to generate virtual topology, the virtual topology comprising a plurality of virtual Peripheral Component Interconnect (PCI) Express devices, a device from the plurality of virtual PCI Express devices having an associated IP address, the IP address being owned by the consolidated I/O adaptor,
a memory to store the virtual topology,
a PCI Express interface to communicate with a host computer system, and
a network layer to communicate with network entities.

26. A machine-readable medium having stored thereon data representing sets of instructions which, when executed by a machine, cause the machine to:
receive a request to create a virtual Peripheral Component Interconnect (PCI) Express device;
determine, from the request, a type of the virtual PCI Express device;
generate a configuration header, the configuration header being in a format of a PCI Express device configuration header; and
store the configuration header.

27. A system comprising:
means for receiving a request to create a virtual Peripheral Component Interconnect (PCI) Express device;
means for determining, from the request, a type of the virtual PCI Express device;
means for generating a configuration header, the configuration header being in a format of a PCI Express device configuration header; and
means for storing the configuration header.
